(19) United States
(12) Patent Application Publication
(10) Pub. No.: US 2016/0230449 A1
(43) Pub. Date: Aug. 11, 2016

(54) PROTECTIVE ASSEMBLY FOR GATES AND BARRIERS

(71) Applicant: Lily ROBERTSON-SHARMA, Birmingham West Midlands (GB)

(72) Inventor: Lily Robertson-Sharma, Birmingham West Midland (GB)

(21) Appl. No.: 15/023,084

(22) PCT Filed: Sep. 19, 2014
(86) PCT No.: PCT/GB2014/052866

§ 371 Date: Mar. 18, 2016

(30) Foreign Application Priority Data
Sep. 19, 2013 (GB) 1316676.4
Dec. 31, 2013 (GB) 1323175.8

(51) Int. Cl. E06B 9/02; A47D 13/00

(52) U.S. Cl. CPC E06B 9/02; A47D 13/00

(57) ABSTRACT

A protective assembly for a gate or a barrier structure includes a flexible padding structure including a padding material, and one or more fasteners. The flexible padding structure is sized and shaped to correspond with the size and shape of the frame and the size and shape of the plurality of vertical bars defining the gate or barrier structure. The flexible padding structure is fitted on the gate or barrier structure and fastened thereto by the fasteners, and extends over the outer surface thereof so as to cover substantially the entire external surface area of the frame and the vertical bars of the barrier or gate structure, with there being padding material provided over most or all of the frame, most or all of the vertical bars, most or all of the inside face, and most or all of the outside face.

### CROSS-REFERENCE TO RELATED APPLICATIONS

This is a U.S. National Stage of Application No. PCT/GB2014/052866 filed on 19 Sep. 2014. Priority under 35 U.S.C. §119(a) and 35 U.S.C. §365(b) is claimed from GB Patent Application No. 1316676.4 filed on 19 Sep. 2013 and GB Patent Application No. 1323175.8, filed on 31 Dec. 2013, the disclosures of which are also incorporated herein by reference.

### BACKGROUND OF THE INVENTION

The present invention relates to a protective assembly for gates and barriers, and more particularly to a protective assembly comprising a flexible padding structure which substantially covers the entire external surface of the frame and vertical bars of a gate or barrier, in order to protect children from getting injured when impacting against the gate or barrier. Young children, especially infants and toddlers, are usually confined within cribs, playpens or in a specific space by the use of gates or barriers to keep them in a safe zone away from potential dangers. For example, removable barriers and gates are used for restricting the movement of the children and prevent children from accessing dangerous areas or specific locations such as stairs or balconies. These safety barriers and gates are often temporarily installed at the top or bottoms of stairways, sealing doorways between adjacent rooms or at balcony entries.

Typically gates and barriers, especially the barriers forming playpens and cribs, and safety gates and safety barriers for children, are made from metal, wood or plastic. They are usually rigid structures, comprising a frame and a plurality of vertical bars (which may, for example, be in the form of rods or balusters or poles or slatted walls or the like). The frame is made up of upper and lower rails that run parallel to each other and in use are positioned horizontally, and two end rails, a left end rail running from the left hand end of the upper rail to the left hand end of the lower rail, and a right end rail running from the right hand end of the upper rail to the right hand end of the lower rail, where these end rails are positioned vertically in use. The vertical bars are located between the two end rails and in use are parallel to these end rails and each other. In use the vertical bars extend from the upper rail to the lower rail. Thus in use the barrier has horizontally spaced bars across its width, from the left hand rail to the right hand rail; the size of the spaces and whether the spaces are regular or different across the width can be down to the design of each product.

Although these safety fence systems confine children in a safe area, frequently children's limbs can get caught between bars or the child accidentally might strike their head on the rigid frame or bars. A number of solutions are known to protect children from becoming injured when coming into contact with the hard bars.

“Crib bumpers”, which provide padded protection for cribs, have long been known and widely used. Traditional flat panel style crib bumpers go back at least 50 years and have usually consisted of a large panel of padded fabric fastened to the inside of the crib bars to prevent injury to a child while rolling around in the crib.

Variations on the idea of a crib bumper have been developed over the years. For example, U.S. Pat. No. 6,772,457 discloses a pad that consists of a plurality of segments that are attached together on the outside of the baby crib with fasteners, so that if the segments become detached from the baby crib and from adjacent segments, the detached segment will fall outside of the crib where it does not present a danger of strangulation or suffocation to a baby located within the crib.

However, traditional flat panel bumpers can reduce airflow through the crib and children can also use them as a step to help escape the crib resulting in a fall on the outside of the crib. These factors have caused the American Paediatric Society to recommend that traditional flat panel bumpers no longer be used.

Another common solution is to provide individual padding to each bar of a crib or gate, allowing improved airflow through the crib to address airflow concerns that caused experts to advise against using traditional flat panel style bumper pads.

For example, CA2446350 provides a baby crib pad which totally pads each of the crib bars, to help prevent bruises and other injuries which can occur when children are able to raise themselves up above the level of the traditional flat panel style bumper pads.

Furthermore, EP1550388 discloses modular safety structures comprising a plurality of tubular elements to wrap completely around each of the vertical supports and horizontal railings of a crib.

In US 2008/0034499 protective pads are used to cover each of the individual balusters of baby cribs or safety gates/room dividers.

However, these solutions comprise bumpers and pads which need to be fitted individually to each bar, generally leaving the frame or other parts of the crib, playpen or gate unprotected. In addition, the need to have individual bumpers or pads for each bar means that fitting the protection is fiddly and time consuming. There is also a problem in that individual bumpers may be lost or mislaid, meaning that there are not enough bumpers to cover each bar. This is clearly undesirable.

Moreover, although the padding of individual bars allows airflow through the crib, playpen or gate, it also leaves a space for the children's limbs to get trapped between the bars, especially if the child is still very young or small in stature, and therefore the parent or guardian may be concerned by this.

Thus, the prior art generally describes devices that are not ideal solutions in terms of safety and practicality, and that merely provide individual modular pads that wrap around individual bars or that completely cover the full area as in the case of flat panels.

However, without any type of padding in use on the bars, children are in danger of becoming injured if they hit the bars or the frame, e.g. if they strike their face, head or body against them.

Also, without the use of some type of pad, children often extend their arm or leg, or even their head, between the bars, where it can become stuck.

### BRIEF SUMMARY OF THE INVENTION

The present invention provides, in a first aspect, a protective assembly for a gate or a barrier structure, where this gate or barrier structure is of the type comprising a frame and a plurality of vertical bars, wherein the frame is made up of an upper rail and a lower rail (which may run parallel to each other and may in use be positioned horizontally) and two end rails, a left end rail running from the left hand end of the upper rail to the left hand end of the lower rail, and a right end rail running from the right hand end of the upper rail to the right hand end of the lower rail, where these end rails are positioned vertically in use, and wherein the vertical bars are located between the two end rails and in use are parallel to these end rails and each other and extend from the upper rail to the lower rail. The protective assembly comprises a flexible padding structure and one or more fasteners. The flexible padding structure is sized and shaped to correspond with the size and shape of the gate or barrier structure and is designed such that, in use, the flexible padding structure is fitted on the gate or barrier structure and fastened thereto by the fasteners, and extends over the outer surface thereof so as to cover substantially the entire external surface area of all the frame and vertical bar elements of the barrier or gate structure.

When it is stated that the flexible padding structure is sized and shaped to correspond with the size and shape of the gate or barrier structure, it will be appreciated that the flexible padding structure should therefore be sized and shaped to correspond with the size and shape of the frame and should be sized and shaped to correspond with the size and shape of the plurality of vertical bars.

The skilled person will appreciate that a gate or barrier structure will have an inside face and an outside face. In other words, there is one face that, in use, will face inside (e.g. towards the inside of a crib, or the inside of any other enclosed area) and there is one face that, in use, will face outside (e.g. towards the outside of a crib, or the outside of any other enclosed area).

The skilled person will also appreciate that the flexible padding structure will comprise padding material. Details of types of material that may be used are described later on in this document. The terms padding material and cushioning material are used interchangeably in the present document.

When reference is made to the fact that the flexible padding structure is designed such that, in use, the flexible padding structure is fitted on the gate or barrier structure and fastened thereto by the fasteners, and extends over the outer surface thereof so as to cover substantially the entire external surface area of all the frame and vertical bar elements of the barrier or gate structure, it will be appreciated that there will therefore be:
a) padding material provided over most or all (e.g. from 60 to 100%) of the frame, and
b) padding material provided over most or all (e.g. from 60 to 100%) of the vertical bars, and
c) padding material provided over most or all (e.g. from 60 to 100%) of the inside face of the gate or barrier structure, and
d) padding material provided over most or all (e.g. from 60 to 100%) of the outside face of the gate or barrier structure.

In general, in the present invention “most or all” refers to over 50%, especially 60% or more, such as 70% or more, preferably 75% or more, or 80% or more, especially 85% or more, 90% or more, 95% or more, or even 99% or more, such as 100%.

For each of the features a) to d) noted above the amount of padding material in terms of a percentage of the surface covered may be the same or different.

The amounts of padding material as stated are given with respect to the percentage of the exterior surface of the relevant portion of the gate or barrier structure that is covered by padding material. The measurement is therefore with respect to solid surfaces of the gate or barrier structure that are covered by padding material. It is not with respect to any gaps or spaces in the gate or barrier structure (e.g. spaces between bars) that may or may not be covered.

Therefore, when assessing the coverage of the frame, the surface area of the solid frame can be determined, and the surface area of the solid frame that is covered with padding material can be determined, and a percentage coverage can thus be calculated.

Meanwhile, when assessing the coverage of the vertical bars, the surface area of the solid vertical bars can be determined, and the surface area of the solid vertical bars that is covered with padding material can be determined, and a percentage coverage can thus be calculated.

When assessing the coverage of the outside face, the surface area of the solid outside face (i.e. not including any gaps or spaces) can be determined, and the surface area of the solid outside face (i.e. not including any gaps or spaces) that is covered with padding material can be determined, and a percentage coverage can thus be calculated.

Accordingly, when reference is made to padding material being provided over most or all of the outside face of the gate or barrier structure, the ‘outside face’ is only intended to be the solid parts of the gate or barrier structure that, in use, present an outside face. Thus it is the frame and vertical bars that make up the outside face that are substantially provided with padding material. It is not essential for any of the gaps or spaces between frame and/or vertical bars to be provided with padded material. Indeed, there is an additional benefit for airflow and visibility to be maintained for some or all of the gaps or spaces between frame and/or vertical bars to not be provided with any padded material.

In one embodiment, therefore, it is only the frame and vertical bars that make up the outside face that are substantially provided with padding material.

When assessing the coverage of the inside face, the surface area of the solid inside face (i.e. not including any gaps or spaces) can be determined, and the surface area of the solid inside face (i.e. not including any gaps or spaces) that is covered with padding material can be determined, and a percentage coverage can thus be calculated.

Accordingly, when reference is made to padding material being provided over most or all of the inside face of the gate or barrier structure, the ‘inside face’ is intended to be the solid parts of the gate or barrier structure that, in use, present an inside face. Thus it is the frame and vertical bars that make up the inside face that are substantially provided with padding material. It is not essential for any of the gaps or spaces between frame and/or vertical bars to be provided with padded material. Indeed, there is an additional benefit for airflow and visibility to be maintained for some or all of the gaps or spaces between frame and/or vertical bars to not be provided with any padded material.

In one embodiment, therefore, it is only the frame and vertical bars that make up the inside face that are substantially provided with padding material.

In one preferred embodiment, therefore, the invention provides a protective assembly for a gate or a barrier structure, the gate or barrier structure being of the type comprising a frame and a plurality of vertical bars, the gate or barrier structure having an inside face and an outside face, wherein the frame is made up of an upper rail and a lower rail (which may run parallel to each other and may in use be positioned horizontally), and two end rails, a left end rail running from the left hand end of the upper rail to the left hand end of the lower rail, and a right end rail running from the right hand end of the upper rail to the right hand end of the lower rail, where these end rails are positioned vertically in use, and wherein the vertical bars are located between the two end rails and in use are parallel to these end rails and each other and extend from the upper rail to the lower rail,
the protective assembly comprising:
a flexible padding structure comprising padding material, and
one or more fasteners,
   wherein the flexible padding structure is sized and shaped to correspond with the size and shape of the frame and with the size and shape of the plurality of vertical bars and wherein, in use, the flexible padding structure is fitted on the gate or barrier structure and fastened thereto by the fasteners, and extends over the outer surface thereof so as to cover substantially the entire external surface area of the frame and the vertical bar elements of the barrier or gate structure, with there being padding material provided over most or all of the frame, and with there being padding material provided over most or all of the vertical bars, and with there being padding material provided over most or all of the inside face, and with there being padding material provided over most or all of the outside face.

Thus the present invention provides a protective assembly for gates and barriers, such as safety gates, cribs, play areas (e.g. play pens) and other safety devices, which overcomes the disadvantages of using bumpers and pads described in the prior art.

In many cases the gate or barrier structure will be of the type comprising a frame and a plurality of vertical bars, the gate or barrier structure having an inside face and an outside face, wherein the frame is made up of an upper rail and a lower rail, which run parallel to each other and in use are positioned horizontally, and two end rails, a left end rail running from the left hand end of the upper rail to the left hand end of the lower rail, and a right end rail running from the right hand end of the upper rail to the right hand end of the lower rail, where these end rails are positioned vertically in use, and wherein the vertical bars are located between the two end rails and in use are parallel to these end rails and each other and extend from the upper rail to the lower rail.

It will be appreciated that some gate or barrier structures have graduated heights, however, such that the left end rail and the right end rail are not the same height, and therefore the upper rail and the lower rail will not necessarily run parallel to each other and/or upper rail and the lower rail will not necessarily be positioned horizontally in use. It may be that the upper rail runs directly linearly from the left end rail to the right end rail and therefore the upper rail is at an angle to the lower rail. It may be that the upper rail is stepped in shape, and therefore it may be formed from multiple sections, some of which are parallel to the lower rail but some of which are not.

The invention can be applied to such gate or barrier structures.

It will be also appreciated that some gate or barrier structures are intended for use on slopes, such that the upper rail and the lower rail will not be positioned horizontally in use.

The invention can be applied to such gate or barrier structures.

The protective assembly provided by the present invention reduces the risk of children pulling at or removing sections of individual padding around individual bars, as in current systems, and provides an improved protection.

Further, the protective assembly provided by the present invention can allow airflow through the barrier or gate structure.

Fitting the assembly is more straightforward than needing to secure separate pieces of padding around each bar individually, and there is no risk that individual bumpers may be lost or mislaid, meaning that there are not enough bumpers to cover each bar.

The present invention provides a protective assembly which can be easily fitted around any type of gate or barrier to cover the external surface of both the vertical bars and the frame of the gate or barrier with a flexible padding structure. This contrasts with many known systems, which only cover the vertical bars. The provision of padding material over the frame as well as the bars provides a product that better protects against accidental collisions with the gate or barrier.

The protective assembly provided by the present invention is designed to genuinely match the size and shape of the gate or barrier structure, such that the flexible padding structure is sized and shaped to correspond with the size and shape of the frame and to correspond with the size and shape of the plurality of vertical bars. This will therefore suitably leave spaces, between the frame and the vertical bars and/or between the vertical bars, that are uncovered by padded material. This feature of the product has several advantages over typical flat panel bumpers. For example, the protective assembly provided by the present invention allows airflow through the barrier or gate structure. The protective assembly provided by the present invention also reduces the risk of children using the product as a step to help escape over the gate or barrier.

When the flexible padding structure is fitted on the gate or barrier structure, it extends over substantially the entire surface of the frame and of the bars. This means that it covers both the inside face and the outside face of the gate or barrier. There will be padding material provided over most or all of the inside face, and there will be padding material provided over most or all of the outside face. There will be padding material provided over most or all of the frame, and there will be padding material provided over most or all of the vertical bars. Thus the product provides padding protection over most or all of the surface of frames and vertical bars.

Thus the present invention provides improved protection for children, regardless of the direction from which they approach the gate or barrier. The assembly provides a secure safety cushion for any child coming into contact with the gate or barrier, from any direction. It is an important feature of the invention that the product provides protection for children when they are outside the gate or barrier, as well as when they are inside the gate or barrier. This is beneficial in terms of providing enhanced protection against accidental collision with the gate or barrier. It is also beneficial in that when a person (e.g. a parent or carer) is setting up the gate or barrier they do not have to be concerned about which way is the right way round for the gate or barrier, because there is padded protection on both sides. This contrasts with many prior systems for cribs, where there is only protection on the side that faces into the crib (the inside face) and so the product must be set up in the correct orientation.

The assembly may optionally also cover other elements of the gate or barrier, such as extension panels or handles, which cannot be protected with typical bar pads or bumpers. With or without this feature, the protective assembly functions as described herein.

In one embodiment, the invention provides a protective assembly comprising a flexible padding structure which is fitted around most, substantially all, or all of the entire external surface area of the gate or barrier structure. For example, 60% or more, such as 70% or more, preferably 75% or more, 80% or more, especially 85% or more, 90% or more, 95% or more, or even 99% or more of the external surface area of the gate or barrier structure may, in use, be covered by the flexible padding structure.

In one embodiment, the invention provides a protective assembly comprising a flexible padding structure which, in use, is fitted around most, substantially all, or all of the entire external surface area of the frame of the barrier or gate structure and which is fitted around most, substantially all, or all of the entire external surface area of the vertical bar elements of the barrier or gate structure. Preferably, the flexible padding structure comprises padding material and in use there is padding material provided over 60% or more, such as 70% or more, 75% or more, 80% or more, 85% or more, 90% or more, 95% or more, or even 99% or more of the frame; in one embodiment it is provided over 75 to 100% of the surface, such as from 85 to 100%. Preferably, the flexible padding structure comprises padding material and in use there is padding material provided over 60% or more, such as 70% or more, 75% or more, 80% or more, 85% or more, 90% or more, 95% or more, or even 99% or more of the vertical bars; in one embodiment it is provided over 75 to 100% of the surface, such as from 85 to 100%. Preferably, the flexible padding structure comprises padding material and there is padding material provided over 60% or more, such as 70% or more, 75% or more, 80% or more, 85% or more, 90% or more, 95% or more, or even 99% or more of the inside face; in one embodiment it is provided over 75 to 100% of the surface, such as from 85 to 100%. Preferably, the flexible padding structure comprises padding material and there is padding material provided over 60% or more, such as 70% or more, 75% or more, 80% or more, 85% or more, 90% or more, 95% or more, or even 99% or more of the outside face; in one embodiment it is provided over 75 to 100% of the surface, such as from 85 to 100%. Preferably, the flexible padding structure is a single piece flexible padding structure.

In one embodiment, the invention provides a protective assembly comprising a flexible padding structure which, in use, is fitted around all of the external surface area of the frame of the barrier or gate structure and all of the external surface area of the vertical bar elements of the barrier or gate structure. In this regard, there may be padding material provided over all of the surface of the frame, and padding material provided over all of the surface of the vertical bars, and padding material provided over all of the surface of the inside face, and padding material provided over all of the surface of the outside face. Preferably, the flexible padding structure is a single piece flexible padding structure.

As noted previously, the measurement of coverage is with respect to solid surfaces of the gate or barrier structure that are covered by padding material. It is not with respect to any gaps or spaces in the gate or barrier structure (e.g. spaces between bars); these may or may not be covered. In one embodiment the gaps or spaces are not covered by padded material.

It is preferable that the flexible padding structure is, in use, fitted all around the external surface area of the gate or barrier structure. This means that the flexible padding structure should, in use, cover the outside face, inside face and any connecting (side) faces as well.

Therefore it is preferable that the padding material of the flexible padding structure is not located just on the inside and outside faces of the frame, but on most or all of the entire exterior surface of the frame—so including any connecting (side) faces as well. Thus the padding material of the flexible padding structure goes all around the frame (rather than just being placed over an outside surface and/or an inside surface).

It will be appreciated that by having padding material going all round the frame, so it is on most or all of the exterior (solid) surface, not just the inside and outside, an improved product is provided, especially when considering protection for small children who might try to put their arms or legs underneath the frame or between the frame and the bars. Padding on the side faces of the frame will provide protection against harm caused from the child trying to put their arms or legs through or under the gate or barrier, adjacent to the frame.

Also, it is preferable that the padding material of the flexible padding structure is not located just on the inside and outside faces of the vertical bars, but on most or all of the entire exterior surface of the vertical bars—so including any connecting (side) faces as well. Thus the padding material of the flexible padding structure goes all around the vertical bars (rather than just being placed over an outside surface and/or an inside surface).

It will be appreciated that by having padding material going all round the bars, so it is on most or all of the exterior (solid) surface, not just the inside and outside, an improved product is provided, especially when considering protection for small children whose arms and legs can fit between the bars. Padding on the side faces of those bars will provide protection against harm caused from the child trying to put their arms or legs through the gate or barrier, between the bars.

The invention may partially or completely pad the gate or barrier structure. The flexible padding structure is shaped to cover most, substantially all or all the entire external surface of the frame and of the vertical bars of the gate or barrier structure. The extent of coverage will depend on whether the gate or barrier structure has any external surfaces in addition to the frame and vertical bars; for example whether there are handles or feet or extension sections or the like. If there are additional sections, then in one embodiment these are not covered by the flexible padding structure of the invention, as it is only required that the flexible padding structure covers the frame and vertical bars. However, in another embodiment, some or all of the additional sections may have their external surfaces covered. This may be due to the flexible padding structure extending over these surfaces and/or due to the provision of one or more additional flexible padding structures for covering some or all of the external surface of the additional sections.

A benefit of the present invention is that when the flexible padding structure of the invention is fitted and secured to the gate or barrier it provides a secure safety cushion for any child coming into contact with the gate or barrier and protects the child from impacting against any part or sharp edges of the gate or barrier.

The invention also provides a protective kit which comprises a protective assembly in accordance with the first aspect together with one or more additional flexible padding structures for covering some or all of the external surface of additional sections. These additional flexible padding structures are shaped and sized to correspond with the size and shape of one or more additional sections added to the gate or barrier, such as fixed sections, gate extensions, individual panels, feet or other support elements, and handles. Each additional flexible padding structure is designed such that, in use, it is fitted on an additional section and can be fastened thereto. They preferably extend over the outer surface of the additional section so as to cover substantially the entire external surface area of all the additional sections.

These additional flexible padding structures therefore help prevent injuries if a child strikes their body against any part of the gate or barrier structure, even when that structure is provided with additional sections.

In general, the protective assembly of the present invention prevents injuries which can occur when children bump against the bars and/or frame, including injuries which may occur when children are outside the gate or barrier and bump against the outside face of the bars and/or frame of the gate or barrier.

It also prevents the risk of the padding being pulled, because it is suitably fitted in one piece around the totality of the gate or barrier (or at least around the frame and vertical bar portions thereof), meaning that the padding is less likely to be pulled away from the barrier or gate (e.g. into a crib or playpen area) and children cannot use the protective assembly to help them climb the gate or barrier. In general, if one or more fasteners are opened, it will not result in the removal of the flexible padding structure.

### BRIEF DESCRIPTION OF THE DRAWINGS

Non-limiting embodiments will now be described, by way of example only, with reference to the accompanying drawings, in which:

FIG. 1 shows a standard gate together with a protective assembly according to the invention.

FIG. 2 is a front view of the protective assembly in place on the standard gate of FIG. 1.

FIG. 3 is a perspective view of a further protective assembly according to the invention fitted on an extendable gate.

FIG. 4 is a perspective view of a further protective assembly according to the invention fitted on a configured gate.

FIG. 5 shows an enlarged section of FIG. 4 showing where there is an elastic element.

FIG. 6 shows an enlarged section showing how in the embodiments of FIG. 3 and FIG. 1 designated holes can be provided in the flexible padding structure to (a) allow wall attachments to be accommodated and to (b) allow access to the gate latch.

FIG. 7 shows an enlarged section showing a Velcro® flap located in the area of the flexible padding structure covering the lower rail.

FIG. 8 shows one example of a medium (protective assembly) for a Standard Gate with a gate extension.

FIG. 9 shows one example of a medium (protective assembly) for an Extendable Gate.

FIG. 10 shows one example of a medium (protective assembly) for a Configure Gate.

### DETAIL DESCRIPTION OF THE INVENTION

The protective assembly of the invention is configured for providing padding to a gate or a barrier structure. The gate or barrier structure may be a safety gate, such as a child's safety gate for preventing children from accessing dangerous areas or specific locations, such as stairs or balconies, or may be a gate or barrier that forms part of a crib or playpen, or may be any other type of gate or barrier.

The main focus of the invention is in respect of gates and barriers that will be contacted by children, especially infants and toddlers (e.g. children aged up to about three years' old), and therefore the features and benefits of the invention are particularly applicable to such products. Safety gates for use in respect of stairs and balconies and the like are clearly an important product to which the invention can be applied.

However, the skilled person reading the present document will appreciate that the invention could also be used in relation to gate or barrier structures intended for use by older children, as well as those aged up to about three years' old. Equally, the invention could be used in relation to gate or barrier structures that are intended to be used by adults, to avoid accidental bumps and scrapes. It can also be appreciated that the invention could be used in relation to gate or barrier structures that are intended to be used by animals, especially pets and/or farm animals.

The present invention is used in relation to a barrier or gate structure wherein the frame and vertical bar elements which form the barrier or gate structure comprise a frame, which has an upper rail and a lower rail and a left end rail and a right end rail, and a plurality (i.e. two or more) vertical bars, wherein these vertical bars are located between the end rails and in use are parallel to these end rails and each other and extend from the upper rail to the lower rail, and wherein in use the flexible padding structure is fitted on the gate or barrier structure and fastened thereto by the fasteners, and extends over the outer surface thereof so as to cover substantially the entire width and length of all the frame and vertical bar elements of barrier or gate structure.

In one embodiment, there may be three or more vertical bars, such as four or more, or five or more, or six or more, or seven or more, or eight or more, or nine or more, or ten or more.

The barrier or gate structure may, in one embodiment, be one having from three to 300 vertical bars, such as from four to 200 or from five to 150 or from six to 100 vertical bars.

For example, the barrier or gate structure may be one having from three to 50 vertical bars, such as from four to 40 or from five to 30 or from six to 25 vertical bars. One option is that there are fewer than 30 vertical bars, e.g. there may be fewer than 25 vertical bars or there may be fewer than 20 vertical bars.

In one embodiment there are from 3 to 30 vertical bars, such as from 4 to 25 or from 5 to 20.

The protective assembly described herein comprises a flexible padding structure which, in use, can be secured to the gate or barrier with one or more fasteners. Accordingly, the protective assembly is provided with one or more fasteners.

The fasteners can be located in any suitable location. For example, the fasteners may be located in the lower part of the flexible padding structure (e.g. in the area of the lower rail of the frame) and/or in the area of the flexible padding structure covering the top frame (e.g. in the area of the upper rail of the frame). Where the gate or barrier is provided with one or more floor base bars (i.e. a bar shaped component that provides a base for the gate or barrier and that, in use, contacts the floor), and where the flexible padding structure covers said floor base bar(s), it may be that fasteners are provided in an area of the flexible padding structure covering the floor base bar(s).

The one or more fastener could be located in the area of the flexible padding structure covering the lower rail and/or the floor base bar and/or the upper rail. Particularly, the one or more fastener may be provided on the part of the flexible padding structure covering the lower rail or (where present) the floor base bar.

The one or more fastener may be provided in the form of flaps located in the lower part of the flexible padding structure covering the lower rail or the floor base bars, e.g. in an area of the flexible padding structure covering the lower rail or the floor base bar(s) and located between vertical bars. Optionally, the protective assembly may further have one or more flap fasteners located in the upper part of the flexible padding structure covering the upper rail, e.g. in an area of the flexible padding structure covering the upper rail and located between vertical bars.

The or each fastener may involve mechanical securing devices or chemical adhesives. Where there is more than one fastener, these may be the same or different. Where there are three or more fasteners, these may be all the same or all different or some may be the same and some may be different.

The mechanical securing devices may involve male and female connectors, e.g. buttons and related holes, tabs and related flaps, snap fit connectors, push fit connectors, hook and loop connectors, zips, or the like.

It can be envisaged that the securing devices may be single sided or may be double sided. For example, the securing devices may be in the form of a component that has hook and loop connectors and is provided with connectors on both sides.

It will be appreciated that the male part of such a connector may be provided on one location on the protective assembly and the female part of such a connector may be provided on a different location on the protective assembly, such that the male and female parts may be brought together and secured once the protective assembly is in place on the gate or barrier. This is the preferred option, because it does not require modification of the gate or barrier.

Where the gate has been modified to include attachment points, the padding can also be provided in relation to those. Therefore in the event of gates having attachment points, whether separately affixed to the gate or otherwise, there may be padding provided in respect of some, most or all of those attachment points.

Alternatively, the male part may be provided on the protective assembly and the female part may be provided on the gate or barrier, or the female part may be provided on the protective assembly and the male part may be provided on the gate or barrier.

In one embodiment, the or each fastener may comprise a hook and loop type securing device, such as that available under the Velcro® brand. Such fasteners are quick and easy to use and therefore parents and guardians of small children may prefer the ease and convenience of such a fastener. However, other male and female connectors can also be utilised, as the skilled reader will immediately appreciate.

The mechanical securing devices may involve frictional securing connectors, such as strings, twists, ties and flocked material, such that the securing can be achieved by friction. For example, knots, bows, twists or other such securing devices using friction may be utilised.

In one embodiment, the or each fastener may comprise a flocked material. As the reader will appreciate, flocked material has many small fibre ‘flocks’ deposited on its surface. In particular, flocked material may have short monofilament fibres on its surface. The ‘flock’ fibres are upstanding on the surface, which gives good slip-or-grip friction properties.

The ‘flock’ fibres may comprise natural or synthetic fibres, for example the fibres may be nylon, rayon or polyester. The fibres may have a diameter of, for example, from 1×10-4 m to 1×10-6 m, in particular the order of about 10-5 m, e.g. from 0.5×10-5 m to 5×10-5 m. The fibres may have a length of, for example, from 0.1 to 10 mm, preferably from 0.25 to 5 mm. The fibres may be provided at a fibre density of, for example, 10 to 500 fibres per mm2, e.g. from 50 to 400 fibres per mm2, such as from 80 to 300 fibres per mm2. The material on which the ‘flock’ fibres are provided may in one embodiment be a textile material but may also be paper or plastic.

Flocked material may be produced by the application of a high-voltage electric field to cause the application of the fibres to a surface of the material that has been coated with adhesive.

The flocked material may, for example, be of the type used in Fuzzy Felt®. Clearly, it is preferred that the material on which the ‘flock’ fibres are provided is, however, flexible rather than stiff.

The ‘flock’ fibres of the material will secure to other fibres, due to the slip-or-grip friction properties of the flocked material. Therefore the or each fastener may be provided as a male and female pair where both are flocked material, or can be provided as a male and female pair where one is flocked material and the other is any other fibre material to which the flocked material can be pressed and secured.

Such flock based fasteners are quick and easy to use and therefore parents and guardians of small children may prefer the ease and convenience of such a fastener. However, other friction based securing devices can also be utilised, as the skilled reader will immediately appreciate.

The chemical adhesives may be of the type known to releasably secure materials together, and may therefore serve in this invention to releasably secure the flexible padding structure to the gate or barrier, or they may be of the type known to permanently secure materials together, and may therefore serve in this invention to permanently secure the flexible padding structure to the gate or barrier.

It can be envisaged that the securing devices may be single sided or may be double sided. For example, the securing devices may be in the form of an adhesive component that is provided with chemical adhesive on both sides.

In one preferred embodiment, the protective assembly has one or more fastener that comprises male and female connectors, such as Velcro® hook and loop strips. Whenever reference is made herein to Velcro® it will be appreciated that any hook and loop type fasteners may be used; the present description is not limited to Velcro® branded products.

Particularly, the Velcro® hook and loop strips (or other hook and loop fasteners) provided as the fasteners can be located in the lower part of the flexible padding structure and/or in the area of the flexible padding structure covering the top frame or the floor base bars.

The skilled reader will appreciate that references to orientation, such as “lower”, “top”, “bottom” and the like, are all intended to be understood with reference to when the product is in use.

In one preferred embodiment, the protective assembly has one or more fastener that comprises Velcro® hook and loop strips (or other hook and loop fasteners) which are located in the area of the flexible padding structure covering the lower rail and/or the floor base bar and/or the upper rail. The protective assembly may have one Velcro® hook and loop strip fastener (or other hook and loop fasteners) which is in the area of the flexible padding structure covering the lower rail or the floor base bar. Particularly, the protective assembly may have one Velcro® hook and loop strip fastener (or other hook and loop fasteners) which runs along the flexible padding structure covering the lower rail or the floor base bar.

In one preferred embodiment, the protective assembly has one or more fastener that comprises Velcro® hook and loop fasteners (or other hook and loop fasteners) in the form of flaps. Particularly, the protective assembly may have one or more Velcro® hook and loop fasteners (or other hook and loop fasteners) in the form of flaps located in the lower part of the flexible padding structure, e.g. covering the lower rail or the floor base bars.

Preferably, each flap is located in an area of the flexible padding structure covering the lower rail or the floor base bars and located between vertical bars. Optionally, the protective assembly may further have one or more flaps fasteners located in the upper part of the flexible padding structure covering the upper rail. Preferably, each flap is located in an area of the flexible padding structure covering the upper rail and located between vertical bars.

In one preferred embodiment, the protective assembly has two or more fasteners that comprises Velcro® hook and loop fasteners (or other hook and loop fasteners) in the form of flaps located in the lower part and the upper part of the flexible padding structure covering the top frame or rail and the lower rail or floor base bars.

Preferably, each flap is located in the area between bars of the flexible padding structure covering the upper rail, lower rail or floor base bar.

In one preferred embodiment, the protective assembly has one or more fastener that comprises Velcro® hook and loop fasteners (or other hook and loop fasteners) in the form of flaps located in the lower part and/or the upper part of the flexible padding structure, e.g. covering the top frame and/or the lower frame of an additional section (or sections) attached to the gate or barrier structure.

The protective assembly described herein comprises a flexible padding structure which is shaped such that it can be fitted around the gate or barrier.

It can be envisaged that the flexible padding structure could be provided in a form where it can be placed over the gate or barrier, and then secured to the gate or barrier with one or more fasteners. For example, the portions of the padding structure that form the front face and back face in use (also referenced elsewhere as the inside face and the outside face) may be provided in a form where they are joined at one edge (the top edge, or the left hand edge, or the right hand edge, or the bottom edge) or at two adjacent edges (the top edge and the left hand edge, or the top edge and the right hand edge, or the bottom edge and the left hand edge, or the bottom edge and the right hand edge). The padding structure can then be placed over the gate or barrier, and then fasteners used to join the remaining edges and secure the structure to the gate or barrier.

Alternatively, it may be in a form where it can be slid onto the gate or barrier, and then secured to the gate or barrier with one or more fasteners. For example, the portions of the padding structure that form the front face and back face in use (also referenced elsewhere as the inside face and the outside face) may be provided in a form where they are joined at two opposite edges (the top edge and the bottom edge, or the left hand edge and the right hand edge) or at three edges (i.e. leaving one edge open, which may be the top edge, or the left hand edge, or the right hand edge, or the bottom edge). The padding structure can then be slid over the gate or barrier, and then fasteners used to join the remaining edge or edges and secure the structure to the gate or barrier.

In one embodiment, the flexible padding structure is shaped such that it can be fitted around the gate by sliding the protective assembly onto the gate. It can then be secured to the gate or barrier with one or more fasteners. This is such that, in use, if one or more fasteners are opened this will not result in the removal of the flexible padding structure.

In one such embodiment, the flexible padding structure is shaped such that it can be fitted around the gate by sliding the protective assembly around one end of the gate. It can then be secured to the gate or barrier with one or more fasteners, so that, in use, if one or more fasteners are opened this will not result in the removal of the flexible padding structure.

The sliding motion may be from the left hand end, or the right hand end, or the top end, or the bottom end.

In one embodiment, the flexible padding structure is shaped such that it can be fitted around the gate by a downwards sliding motion. Thus it may be fitted, for example, by sliding the protective assembly downwards from the top frame to the lower frame or to the floor base bar, and then can be secured to the gate or barrier with one or more fasteners, so that, in use, if one or more fasteners are opened it will not result in the removal of the flexible padding structure.

In one embodiment the protective assembly comprises one or more elastic elements. These may suitably be positioned so that, in use, they cover any hinge points of the gate or barrier section.

In another embodiment, the protective assembly comprises one or more holes in the flexible padding structure. In particular, these may be located to provide access to functional components on the gate or barrier, such as latches or wall attachments.

Preferably such holes are sized and shaped to allow the functional components to function effectively, e.g. to allow latches to move, or to provide space for wall attachments to pass through the hole and be accessed.

The protective assembly of the invention comprises a flexible padding structure. This flexible padding structure comprises a padding material. The flexible padding structure may consist essentially of padding material. The flexible padding structure is sized and shaped to correspond with the size and shape of the gate or barrier structure and is designed such that, in use, the flexible padding structure is fitted on the gate or barrier structure and extends over the outer surface thereof so as to cover substantially the entire external surface area of all the frame and vertical bar elements of the barrier or gate structure.

Therefore, the size and shape of the flexible padding structure comprising a padding material corresponds with the size and shape of the frame and with the size and shape of the plurality of vertical bars. In use, the flexible padding structure is fitted on the gate or barrier structure and fastened thereto by the fasteners, extending over the outer surface thereof so as to cover substantially the entire external surface area of the frame and the vertical bar elements of the barrier or gate structure, with there being padding material provided over most or all of the frame, and with there being padding material provided over most or all of the vertical bars, and with there being padding material provided over most or all of the inside face, and with there being padding material provided over most or all of the outside face.

In one embodiment, the invention provides a protective assembly for a gate or a barrier structure, comprising a flexible padding structure comprising padding material, and one or more fastener, wherein the flexible padding structure is sized and shaped to correspond with the size and shape of the frame and the size and shape of the plurality of vertical bars and wherein, in use, the flexible padding structure is fitted on the gate or barrier structure and fastened thereto by the fasteners, and extends over the outer surface thereof so as to cover substantially the entire external surface area of the frame and the vertical bar elements of the barrier or gate structure, with there being padding material provided over 60% or more, such as 70% or more, 75% or more, 80% or more, 85% or more, 90% or more, 95% or more, or even 99% or more of the frame, and with there being padding material provided over 60% or more, such as 70% or more, 75% or more, 80% or more, 85% or more, 90% or more, 95% or more, or even 99% or more of the vertical bars, and with there being padding material provided over 60% or more, such as 70% or more, 75% or more, 80% or more, 85% or more, 90% or more, 95% or more, or even 99% or more of the inside face, and with there being padding material provided over 60% or more, such as 70% or more, 75% or more, 80% or more, 85% or more, 90% or more, 95% or more, or even 99% or more of the outside face.

In one embodiment, the flexible padding structure according to the invention is sized and shaped to correspond with the size and shape of the frame and the size and shape of the plurality of vertical bars, and, in use, the flexible padding structure is fitted on the gate or barrier structure and fastened thereto by the fasteners, and extends over the outer surface thereof so as to cover substantially the entire external surface area of the frame and the vertical bar elements of the barrier or gate structure, with there being padding material provided over all of the frame, and with there being padding material provided over all of the vertical bars, and with there being padding material provided over all of the inside face, and with there being padding material provided over all of the outside face.

Any suitable material may be used for the flexible padding structure. It may be that most or substantially all of the flexible padding structure is formed from padding material.

In one embodiment the parts of the flexible padding structure that, in use, will cover the frame of the gate or barrier structure and will cover the vertical bars of the gate or barrier structure comprise at least 30% padding material, such as 40% or more, 50% or more, 60% or more, or 70% or more padding material, e.g. 75% or more. In one embodiment the parts of the flexible padding structure that, in use, will cover the frame of the gate or barrier structure and will cover the vertical bars of the gate or barrier structure consist essentially of padding material.

The flexible padding structure comprising a padding material should have a thickness sufficient that the structure does serve to provide padding. The skilled reader will appreciate that a very thin layer of material would not serve to achieve a padding effect and therefore the product would not be a flexible padding structure. The flexible padding structure comprising a padding material should therefore suitably have a thickness of 1 mm or more.

In one embodiment, the flexible padding structure comprising a padding material according to the invention has thickness of 2 mm or more, such as 2.5 mm or more, or 3 mm or more, or 4 mm or more, preferably 5 mm or more, and optionally as much as 10 mm or more. For example, the flexible padding structure may have a thickness of from 2 to 30 mm, e.g. from 2.5 to 25 mm, or from 3 to 20 mm, preferably from 3.5 to 20 mm, such as from 4 to 20 mm, e.g. from 4.4 to 20 mm or from 5 to 20 mm.

The material used for the flexible padding structure comprises a padding material. This may also be referred to as a cushioning material. In a preferred embodiment the flexible padding structure therefore comprises one or more cushioning materials. Suitable cushioning materials might be any impact-absorbing material.

Examples of such cushioning materials include, without limitation, coir fibres, quilted cotton, organic cotton, wool, foam, rubber, and combinations thereof. The foam used in the flexible padding structure can, for example, comprise closed-cell polyethylene foam, memory foam, gel foam, open-cell polyurethane foam or latex foam. It may be that the latex foam contains pockets in which the coir is compacted, or it may simply be that a layer of latex is covered by a layer of coir. In one embodiment, the cushioning material comprises a combination of coir and rubber (e.g. it may be rubberised coir or rubber containing flecks of coir).

The padded characteristic may be enhanced by the material being an inflatable material and therefore being able to be inflated to include a layer of air therein, which will give further cushioning.

Alternatively, the padded characteristic may be solely achieved by the material being an inflatable material and therefore being able to be inflated to include a layer of air therein, which will give cushioning.

In one embodiment the material used for the flexible padding structure of the protective assembly described in present invention comprises one or more layers of materials. These may be provided as any suitable laminate or composite or blend or other combination of materials.

Preferably the materials that will, in use, be on the outside of the product are non-allergenic materials, or are materials that are commonly used in children's products.

Preferably the materials that will, in use, be on the outside of the product are easy to clean, e.g. they may be machine washable or wipe-clean.

It can be beneficial for the materials used for the flexible padding structure to comprise stretchable materials. This will make the structure easier to fit onto the barrier or gate. There may, for example, be elasticated or other stretchable materials included in the material.

The materials used for the flexible padding structure may be natural materials or may be synthetic or may be combinations thereof. Particular examples of natural material that may be used include laminated cotton and organic cotton fibre.

In one embodiment the flexible padding structure comprises at least one internal layer, which in use will be in contact with the barrier or gate, and one outer layer, which in use can be contacted by the child.

Preferably the outer layer is made from material that is non-allergenic and easy to clean.

Preferably the internal layer is made from material that is fire resistant or flame retardant.

In general, examples of materials from which the outer layer of the flexible padding structure can be formed include, but are not limited to cotton, silk, wool, linen, or sateen, polymers, such as poly vinyl chloride, nylons, latex, Lycra®, polyester, and rubber.

The surface of the outer layer of the flexible padding structure can be clear or opaque. It may be, any colour. It may include one or more pattern and/or may be provided with one or more designs.

The surface of the outer layer of the flexible padding structure is preferably of a solid colour. It may have educational designs provided, such as, for example, letters, shapes, pictures, images and/or numbers. These designs may be provided on the inside and/or outside of the gate or barrier.

In one embodiment, the protective assembly according to the invention comprises a flexible padding structure with two or more layers, wherein there is a layer of cushioning material or impact-absorbing material (also known as padding material) and an outer layer, which in use can be contacted by the child.

In one such embodiment, the protective assembly according to the invention comprises a flexible padding structure with three or more layers, wherein there is a layer of cushioning material or impact-absorbing material (also known as padding material) between an internal layer and an outer layer.

In one embodiment, the protective assembly according to the invention comprises a single piece flexible padding structure. This flexible padding structure is sized and shaped to correspond with the entire size and shape of the gate or barrier structure. It is preferably designed such that, in use, the flexible padding structure is fitted as one piece on the gate or barrier structure and fastened thereto by the fasteners, and extends continuously over the outer surface thereof so as to cover substantially the entire width and length of all the frame and vertical bar elements of barrier or gate structure.

In one embodiment, the flexible padding structure according to the invention is a single piece flexible padding structure that is sized and shaped to correspond with the size and shape of the frame and the size and shape of the plurality of vertical bars, and wherein, in use, the flexible padding structure is fitted as one piece on the gate or barrier structure and is fastened thereto by the fasteners, and extends continuously over the outer surface thereof so as to cover substantially the entire external surface area of the frame and vertical bar elements of the barrier or gate structure, with there being padding material provided over most or all of the frame, and with there being padding material provided over most or all of the vertical bars, and with there being padding material provided over most or all of the inside face, and with there being padding material provided over most or all of the outside face.

In one embodiment, the flexible padding structure according to the invention is a single piece flexible padding structure that is sized and shaped to correspond with the size and shape of the frame and the size and shape of the plurality of vertical bars, and wherein, in use, the flexible padding structure is fitted as one piece on the gate or barrier structure and is fastened thereto by the fasteners, and extends continuously over the outer surface thereof so as to cover substantially the entire external surface area of the frame and vertical bar elements of the barrier or gate structure, with there being padding material provided over 60% or more, such as 70% or more, 75% or more, 80% or more, 85% or more, 90% or more, 95% or more, or even 99% or more of the frame, and with there being padding material provided over 60% or more, such as 70% or more, 75% or more, 80% or more, 85% or more, 90% or more, 95% or more, or even 99% or more of the vertical bars, and with there being padding material provided over 60% or more, such as 70% or more, 75% or more, 80% or more, 85% or more, 90% or more, 95% or more, or even 99% or more of the inside face, and with there being padding material provided over 60% or more, such as 70% or more, 75% or more, 80% or more, 85% or more, 90% or more, 95% or more, or even 99% or more of the outside face.

In one embodiment, the flexible padding structure according to the invention is a single piece flexible padding structure that is sized and shaped to correspond with the size and shape of the frame and the size and shape of the plurality of vertical bars, and wherein, in use, the flexible padding structure is fitted as one piece on the gate or barrier structure and is fastened thereto by the fasteners, and extends continuously over the outer surface thereof so as to cover substantially the entire external surface area of the frame and vertical bar elements of the barrier or gate structure, with there being padding material provided over all of the frame, and with there being padding material provided over all of the vertical bars, and with there being padding material provided over all of the inside face, and with there being padding material provided over all of the outside face.

The single piece flexible padding structure may be formed from a single section of material (which may be a layered material such as a laminate material or may be a blend or composite material). Alternatively, the single piece flexible padding structure may be formed from two or more sections of material that have been secured together to form the one piece structure.

The protective assembly of the present invention may have gaps provided in the sections that, in use, will be located between the vertical bars, such that these horizontal spacings between the vertical bars are retained as open gaps, as in the gate or barrier.

However, in one embodiment, the protective assembly of the present invention may optionally further include one or more spacing panels, that in use will be located between the vertical bars, such that one or more of these horizontal spacings between the vertical bars are covered by said spacing panels.

In a preferred such embodiment, a number of spacing panels are provided so that in use each of the horizontal spacings between the vertical bars is covered by one (or more than one) of said spacing panels. However, it can also be envisaged that a number of spacing panels are provided so that, in use, some but not all of the horizontal spacings between the vertical bars are covered by one (or more than one) of said spacing panels. For example, it could be that, in use, every other horizontal spacing between the vertical bars is covered by one of said spacing panels (i.e. there are alternating spacing panels and gaps in the horizontal spacings). There may, therefore, be a spacing panel in half of the horizontal spacings. It could also be that there is a spacing panel in more than half of the horizontal spacings, or in less than half of the horizontal spacings.

The spacing panels are preferably sized and shaped so as to fully cover the horizontal spacings. However, embodiments can be envisaged where they partially cover the horizontal spacings, e.g. they might cover 50% to 90% or more of each of the horizontal spacings, such as 60% or more, 75% or more, 80% or more, 85% or more, 90% or more, or 95% to 99% or more. The spacing panels are preferably substantially the same in terms of size and shape, but they do not have to be identical, so there could be variations between the size and shape of the spacing panels provided for each horizontal spacing.

Preferably the material used for the spacing panels permits the flow of air therethrough. Therefore materials that are permeable to air are preferred.

Preferably the material used for the spacing panels is soft and flexible.

Preferably the material used for the spacing panels is transparent or translucent, but it could optionally be opaque.

Preferably the material used for the spacing panels is not padded. Therefore it is suitably not a cushioning material as mentioned above. In one embodiment the material used for the spacing panels has a thickness of 3 mm or less, such as 2 mm or less or 1 mm or less.

The material used may, for example, be fabrics or polymers. A net or mesh fabric may suitably be chosen.

In general, examples of materials from which the net or mesh fabric can be formed include, but are not limited to, polypropylene, polyester, wool, nylon, viscose, cotton, or silk yarns, vinyl filaments, or yarn coated with vinyl after it is woven or knitted.

In one such embodiment the protective assembly of the present invention comprises a net or a mesh to substantially cover the horizontal spacings between the vertical bars. Preferably there is a net or mesh covering the entire surface of the spacings between the vertical bars.

In one particular preferred embodiment, the protective assembly according to the invention comprises a flexible padding structure, a net or a mesh to substantially cover the horizontal spacings between the vertical bars, and one or more fasteners, wherein the flexible padding structure has two or more layers, wherein at least one such layer comprises cushioning material or impact-absorbing material (also known as padding material) and wherein at least one such layer is an outer layer comprising a natural material.

In another preferred embodiment, the protective assembly according to the invention comprises a flexible padding structure, a net or a mesh to substantially cover the horizontal spacings between the vertical bars, and one or more fasteners comprising Velcro® strips, wherein the flexible padding structure has two or more layers wherein at least one such layer comprises rubber and/or coir and wherein at least one such layer is an outer layer comprising a laminated cotton or organic cotton fibre.

Typical gates and barriers can have one or more additional sections attached to the gate or barrier structure.

For example, there may be a single fixed section on one side of the gate or barrier structure, or fixed sections on each side of the gate or barrier structure.

Additionally, gates and barriers generally have a floor base bar, or feet, or other support elements, located at or near their base or elsewhere, which adds to their stability.

Other additional elements can comprise handles and/or gate extensions.

Therefore if there are one or more additional sections attached to the gate or barrier structure, in one embodiment, the protective assembly of the present invention extends to additionally cover substantially the entire surface of each additional section(s) attached to the gate or barrier structure.

In one embodiment, the barrier or gate structure has one or more additional sections, in addition to the frame and a plurality of vertical bars, and, in use, the flexible padding structure further extends over the outer surface of said additional sections, so as to cover substantially the entire external surface area of the additional sections, with there being padding material provided over most or all of the additional sections.

In one embodiment, the protective assembly according to the invention comprises a single piece flexible padding structure. This flexible padding structure is sized and shaped to correspond with the entire size and shape of the gate or barrier structure and the additional section(s) attached. The flexible padding structure is designed such that, in use, the single piece flexible padding structure is fitted as one continuous piece on the gate or barrier structure, with the additional section(s) attached. The flexible padding structure is fastened thereto by the fasteners, and extends continuously over the outer surface thereof so as to cover substantially the entire width and length of all the frame and vertical bar elements of barrier or gate structure and the additional section(s) attached.

In one embodiment, the flexible padding structure according to the invention is provided as a single piece unit, which is sized and shaped to correspond with the size and shape of the frame and the size and shape of the plurality of vertical bars and the size and shape of the additional sections, and wherein, in use, the flexible padding structure is fitted on the gate or barrier structure and on the additional sections, and fastened thereto by the fasteners, and extends over the outer surface thereof so as to cover substantially the entire external surface area of the frame and the vertical bar elements and the additional sections, with there being padding material provided over most or all of the frame, and with there being padding material provided over most or all of the vertical bars, and with there being padding material provided over most or all of the inside face, and with there being padding material provided over most or all of the outside face, and with there being padding material provided over most or all of the additional sections.

In one embodiment, the flexible padding structure is provided as a single piece unit, which is sized and shaped to correspond with the size and shape of the frame and the size and shape of the plurality of vertical bars and the size and shape of the additional sections, and wherein, in use, the flexible padding structure is fitted on the gate or barrier structure and on the additional sections, and fastened thereto by the fasteners, and extends over the outer surface thereof so as to cover substantially the entire external surface area of the frame and the vertical bar elements and the additional sections, with there being padding material provided over 60% or more, such as 70% or more, 75% or more, 80% or more, 85% or more, 90% or more, 95% or more, or even 99% or more of the frame, and with there being padding material provided over 60% or more, such as 70% or more, 75% or more, 80% or more, 85% or more, 90% or more, 95% or more, or even 99% or more of the vertical bars, and with there being padding material provided over 60% or more, such as 70% or more, 75% or more, 80% or more, 85% or more, 90% or more, 95% or more, or even 99% or more of the inside face, and with there being padding material provided over 60% or more, such as 70% or more, 75% or more, 80% or more, 85% or more, 90% or more, 95% or more, or even 99% or more of the outside face, and with there being padding material provided over 60% or more, such as 70% or more, 75% or more, 80% or more, 85% or more, 90% or more, 95% or more, or even 99% or more of the additional sections.

In one embodiment, the flexible padding structure is provided as a single piece unit, which is sized and shaped to correspond with the size and shape of the frame and the size and shape of the plurality of vertical bars and the size and shape of the additional sections, and wherein, in use, the flexible padding structure is fitted on the gate or barrier structure and on the additional sections, and fastened thereto by the fasteners, and extends over the outer surface thereof so as to cover substantially the entire external surface area of the frame and the vertical bar elements and the additional sections, with there being padding material provided over all of the frame, and with there being padding material provided over all of the vertical bars, and with there being padding material provided over all of the inside face, and with there being padding material provided over all of the outside face, and with there being padding material provided over all of the additional sections

In preferred embodiments, some or all of the additional sections attached to the gate structure have their external surfaces covered, either due to the flexible padding structure extending over these surfaces and/or due to a protective assembly of the invention comprising an additional flexible padding structure which is fitted around most, substantially all, or all of the entire external surface area of the additional section(s).

In one embodiment, the protective assembly can be designed to cover one or more additional sections attached to the gate or barrier structure, such as a fixed section attached to one or both sides of the gate or barrier structure, floor base bars or other support elements, handles or gate extensions.

In one particular embodiment, the protective assembly comprises an additional flexible padding structure which is sized and shaped to correspond with the size and shape of the additional section(s) attached to a gate or barrier structure and wherein in use the additional flexible padding structure is fitted on the additional section(s) attached to the gate or barrier structure and fastened thereto by fasteners, and this additional flexible padding structure extends over the outer surface thereof so as to cover substantially the entire width and length of the additional section(s).

In one embodiment, the additional flexible padding structure which is sized and shaped to correspond with the size and shape of the additional section(s) and wherein, in use, said separate pieces are fitted on the additional sections and are fastened thereto by fasteners, and these separate pieces extend over the outer surface thereof so as to cover substantially the entire external surface area of the additional sections, with there being padding material provided over most or all of the additional sections. Preferably, there is padding material provided over 60% or more, such as 70% or more, 75% or more, 80% or more, 85% or more, 90% or more, 95% or more, or even 99% or more of the additional sections. More preferably, there is padding material provided over all of the additional sections.

For example, centre opening gates additionally comprises a floor base bar at their base and two fixed sections, one on each side of the middle gate. Therefore, in one embodiment, the protective assembly provided in the present invention can be designed to cover a centre opening gate. Preferably, the protective assembly comprises a single flexible padding structure which in use, is fitted as one continuous piece on the gate and fastened thereto by the fasteners, and extends continuously over the outer surface thereof so as to cover substantially the entire width and length of all the frame, vertical bar elements of the gate structure, floor base bar and fixed sections on each side.

As discussed above, the protective assembly of the invention can be used to protect a variety of gates and barriers.

In one embodiment, the protective assembly provided in the present invention can be designed to cover any type or model of gate used to seal off doorways, stairs, restrict the movement of children or prevent children from accessing certain areas. Preferably, the gate is a safety gate, a baby gate or a protective gate.

In another embodiment, the protective assembly can be designed to cover a barrier used to close doorways, enclosed children in a specific area or used as room divider. In one particular embodiment the barrier is the barrier of a playpen.

In another embodiment, the protective assembly can be designed to cover freestanding gates or barriers which comprise a series of panels that can be interlocked to form an enclosed area with or without a door.

In a second aspect, the present invention provides a protected gate or barrier structure, which comprises a gate or barrier structure having a protective assembly according to the first aspect fitted thereto.

Preferably, the protective assembly comprises a flexible padding structure which is fitted around most, substantially all, or all of the entire external surface area of the gate or barrier structure. For example, 60% or more, such as 70% or more, 75% or more, 80% or more, 85% or more, 90% or more, 95% or more, or even 99% or more of the external surface area of the gate or barrier structure may, in use, be covered by the flexible padding structure.

In a third aspect, the present invention provides the use of a protective assembly in accordance with the first aspect of the invention as a cover for a gate or a barrier structure.

In a fourth aspect, the invention further provides a kit comprising a protective assembly in accordance with the first aspect, in combination with a gate or barrier structure.

In one particular embodiment the kit comprises a gate or barrier structure comprising a frame and vertical bar elements, and a protective assembly comprising a flexible padding structure. This flexible padding structure is sized and shaped to correspond with the size and shape of the gate or barrier structure and is designed such that, in use, the flexible padding structure is fitted on the gate or barrier structure and extends over the outer surface thereof so as to cover substantially the entire external surface area of all the frame and vertical bar elements of the barrier or gate structure.

A typical gate and barrier structure used for children safety comprises a frame and a plurality of vertical bars, wherein the frame is made up of a spaced parallel upper rail (1) and lower rail (2). Corresponding ends of these rails are joined to a vertical end rail (3) and spaced, parallel, vertically oriented bars (4) are located between the two end rails and parallel to these end rails, and extending from the upper rail to the lower rail.

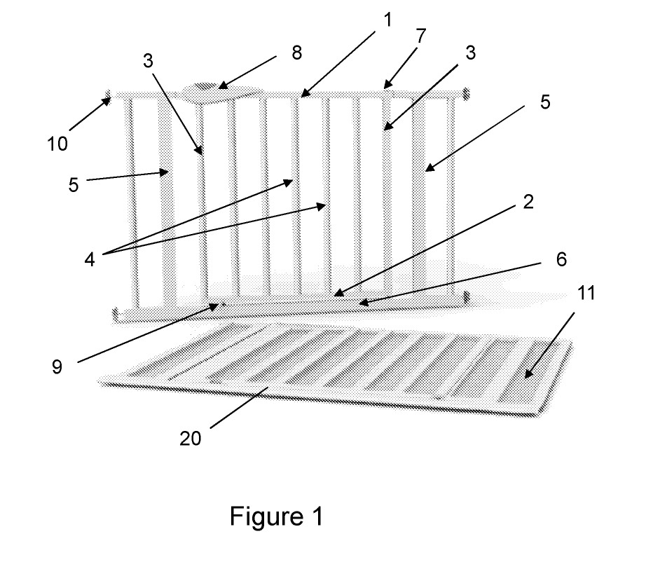

Additionally, as seen in FIG. 1, a gate can have fixed sections (5) on each side and a gate structure in the middle. Centre opening gates generally have a floor base bar (6) at their base which adds to their stability but can sometimes be hazardous. Gates generally have different hinge points (7) to allow the movement of the gate which can have different types of opening mechanism; the most common are handles (8). Additional latch mechanisms (9) are often found on safety gates, and wall attachments (10) on the sides are provided for the gate to be securely mounted in place, such as in an entrance, doorway, door frame, or the like.

As seen in FIG. 1, the protective assembly (20), which is accordance with the invention, is in one piece and is crafted to have the size and shape of the gate. Therefore when it is fitted it can cover with the flexible padding structure the entire width and length of all the frame and vertical bar elements of the gate structure. In addition, the flexible padding structure can cover the entire width and length of all the frame and vertical bar elements of the fixed sections (5).

The openings within the gate which are located between the spaced bars allow a parent or other carer to see through the barrier or gate, to keep close watch on the children behind the gate.

The protective assembly (20) in FIG. 1 further comprises a mesh or net (11) to cover partially or totally the space between the bars, providing security together with some degree of visibility.

The net positioned between the bars allows visibility to be retained through the gates and the air to flow through while stopping children from being able to reach through bars.

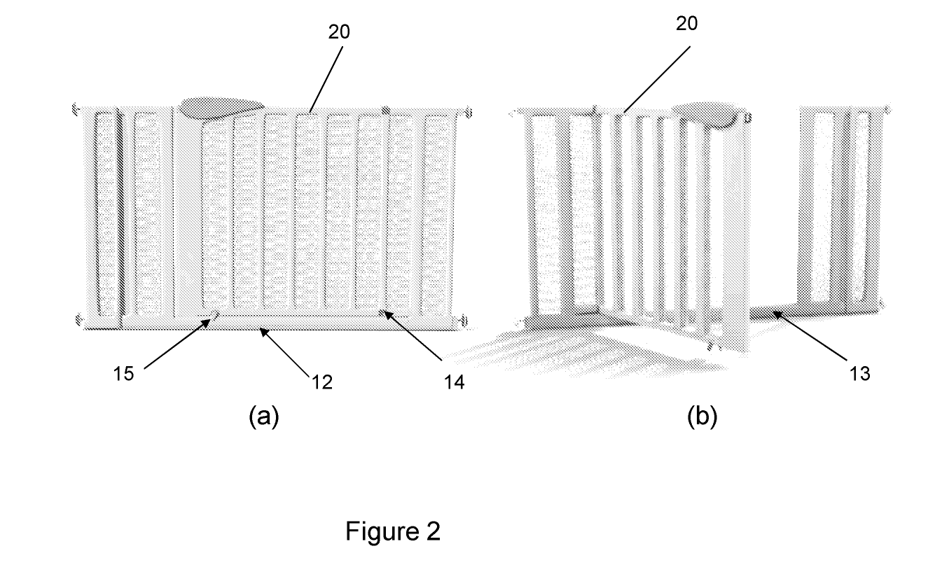

As seen in FIG. 2, the protective assembly (20) is fitted in one piece and continuously covers the entire surface of the gate. The protective assembly can be fitted, for example, by sliding the protective assembly around one end of the gate; the assembly then can travel in a sliding motion along the base of the gate frame until it reaches the opposite end and thus all of the gate is slotted into the protective assembly.

Velcro® strips (12) are located on the channel part (13) of the protective assembly which fits along the floor base bar (6). Each of the Velcro® strips is permanently secured along one side of the gate, preferably in the side of the gate away from the children. These strips are used to secure the protective assembly in place over the gate.

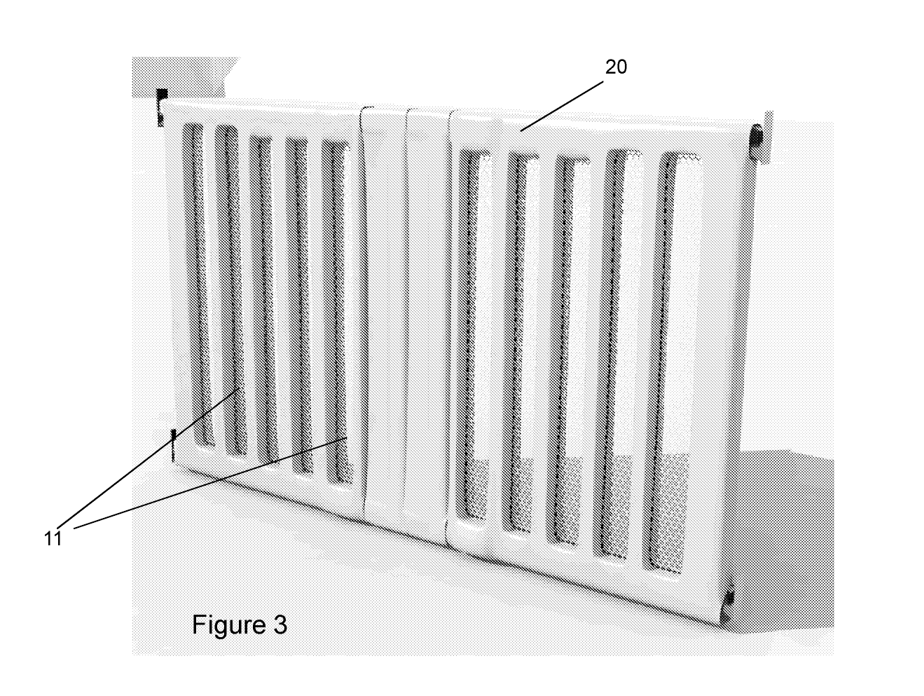

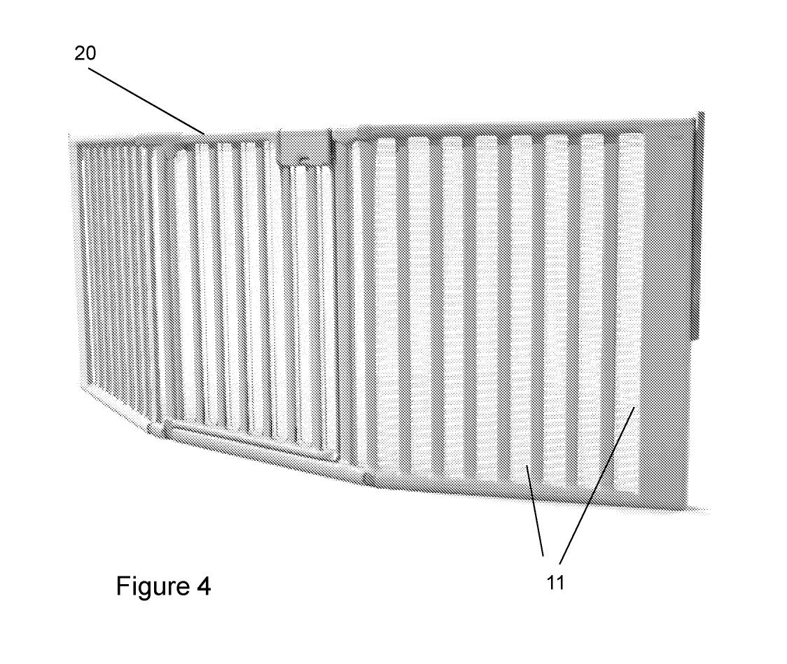

FIGS. 3 and 4 show a protective assembly (20) fitted onto an extendable gate and a configured gate respectively. Thus it can be appreciated how a protective assembly according to the invention can be designed for a variety of gate shapes.

In particular, the invention may be used with gate or barrier structures where there is one or more additional section, in addition to a main section (with the frame and plurality of vertical bars). The flexible padding structure may be shaped and sized so as to further extend over the outer surface of said additional sections, so as to cover substantially the entire external surface area of the additional sections. The additional sections do not all need to be the same. The additional sections may be temporary or permanent; there could be one or more temporary and/or one or more permanent sections.

An extendable gate can be extended by the use of add-in gate sections that can be added as required. An extendable gate can be seen as being made up of one main section (with a frame and plurality of vertical bars) and then additional sections. There may be one or more additional sections, e.g. two or more additional sections.

The configured gate comes in three connected sections. The frame of the gate is hinged.

One end of the protective assembly, which is in one piece, can be slid onto the end of the gate situated behind the gate door hinge. With the gate door open, the door part of the protective assembly can be slid onto the gate door. By folding the opposite end of the gate inwards, until a triangle shape is formed, the other end of the protective assembly can be slid onto the gate side. The gate is then straightened so that the floor base bar beneath the door is covered by the channel part (13) of the protective assembly. The Velcro® strips are then used to secure the protective assembly. With the protective assembly fitted on the gate, this is ready to be installed in the appropriate place.

The protective assembly (20) in FIGS. 3 and 4 further comprises a mesh or net (11) to cover partially or totally the space between the bars, providing security together with some degree of visibility.

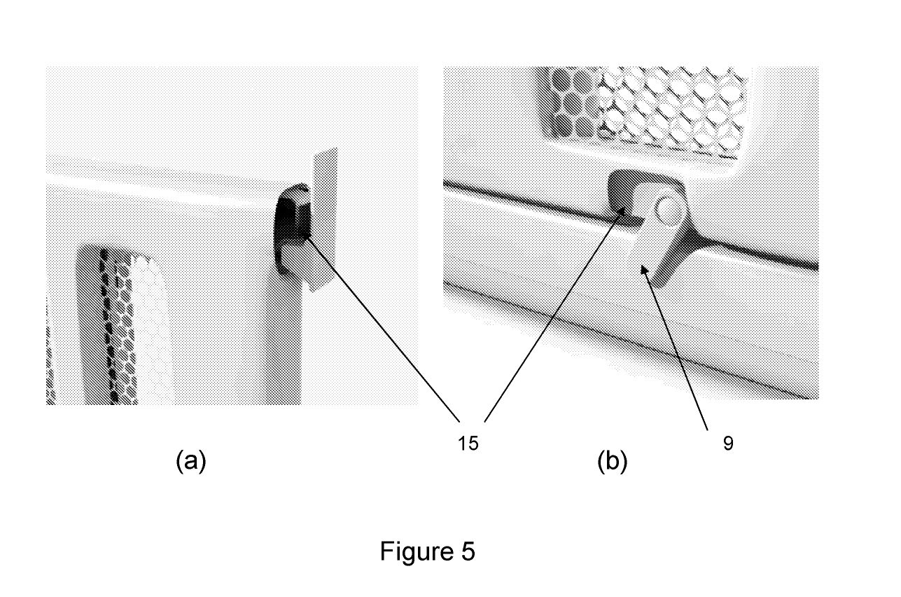

As seen in FIG. 2 and FIG. 5, when the protective assembly is secured on the gate the elastic elements (14) allow the cover to stretch when the gate door is being opened and closed or when different sections of the gate are folded to fit in a specific place. The elastic elements can be, for example, stitched or attached (or otherwise incorporated) into the flexible padding structure at specific places where the door has a hinge point. As seen in FIG. 5, hinge points can be located in upper rail and lower rail.

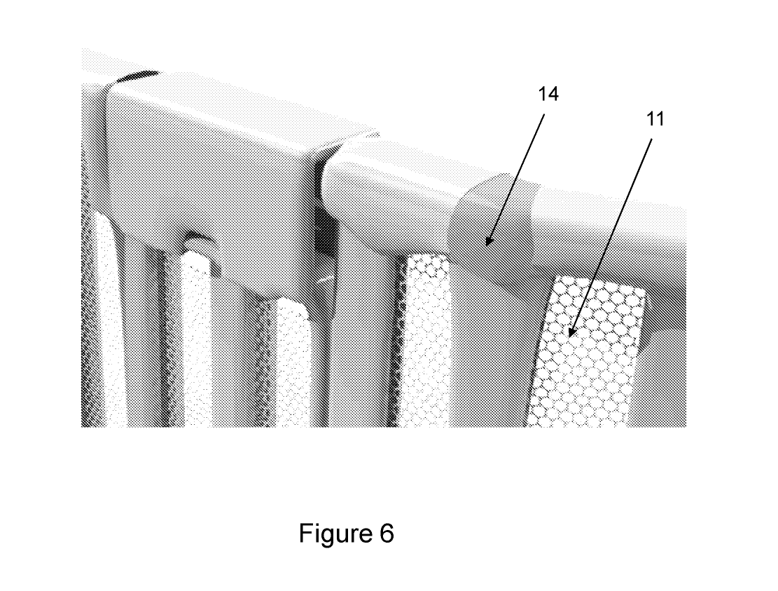

Additionally, as seen in FIG. 2 and FIG. 6, the protective assembly can have one or more designated holes (15) along the surface of the flexible padding structure to allow wall attachments (10) to be accommodated and to reveal latches (9) on the gate so said latches can move (FIGS. 6(a) and (b)).

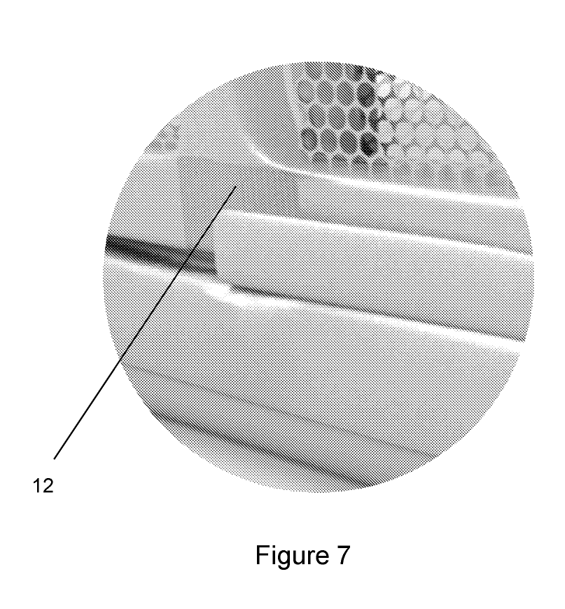

FIG. 7 shows a protective assembly of the invention in place on a standard gate with a Velcro® flap (12) located in the area of the flexible padding structure covering the lower rail (2).

It will be appreciated that the protective assembly of the present invention is effective against impact. Consequently, the flexible padding structure can be made of various different materials which provide an impact absorbing effect, as discussed above.

The flexible padding structure may be of different thickness depending on the degree of cushioning that is desired.

Additionally, the flexible padding structure can have one or more layers of different materials, as discussed above.

The protective assembly of the invention can be used in relation to a range of different gate or barrier structures. It will be appreciated the invention is not limited to the types of gate illustrated in the drawings. Other gate and barrier structures can also be applicable.

One preferred type of gate is a safety gate. The term safety gate refers to any gate designed to prevent children from accessing selected areas. The also term encompasses safety gates with any add-ons, to set up a gate of almost any shape and dimensions, e.g. the add-ons may permit a variety of width gates to be provided.

Examples of safety gates include, without limitation, Pressure Mounted Safety

Examples of safety gates include, without limitation, Pressure Mounted Safety Gates, Hardware Mounted Safety Gates, Yard Gates, Wall-Mounted Safety Gates, Freestanding Gates, Walk-Through Stair Gate or Pass-Thru Safety Gates, Barrier Safety Gates, Configured gates, Extendable Gates, Baby Play Gate, Wide Baby Gates, Baby gate Play Yard and Odd Space Safety Gates. The invention further relates to intermediate mediums (in the above sections and the claims these are referenced as protective assemblies) on, over, at or in the regions of gates such as Safety and Stair Gates.

Gates can be made from metal, wood and plastic, commonly with vertical bars and strength. Although gates can offer secure barriers, preventing entry into unsafe areas; injuries can occur on the exposed gates from falling, bumping into them and for example, by infants getting their limbs caught between the exposed bars.

To minimise the effect of impact on or at the gate, the present invention proposes intermediate mediums (protective assemblies) which can provide a solution to contact being made with the gate.

Intermediate mediums (protective assemblies) will provide a measure by which injury is less likely to occur through contact with the gate itself

The mediums (protective assemblies) do not compromise the structure of the gate and visibility through the gate may be maintained.

Where appropriate, materials in mediums (protective assemblies) can be non-allergenic, shock absorbent and durable, suitable for regular contact and long lasting use.

Mediums (protective assemblies) provide an intermediate solution to direct contact with gates, gated arrangements and gated formations; being for use with multiple types and styles of gates. Mediums (protective assemblies) can extend to, be on, over, at or be situated in the region beyond the gate. Mediums (protective assemblies) can fit round the gate partially, entirely and/or equally and/or be in at least one piece on, over, at or in the region of the gate. The medium (protective assemblies) can be outside the gate and/or removable from the gate, if not built on; being purpose-built onto the gate itself, without requiring detachment and attachment points or, including those. Mediums (protective assemblies) secure gates by mediating against impact on the bars and frame of the gate which can include mediation less than, up to and until gate attachment points such as at a wall or to a door frame, or beyond and outside these points. Mediums (protective assemblies) when applied, and/or placed, and/or, in operation inhibit contact with the gate itself.

For example, in the case of a medium (protective assembly) such as the padding in FIG. 7, cushioning covering bars may be: spaced in parallel relation to bars 1, have top and bottom ends complementary to the gate door 2 and frame 3 as well as two opposed vertical and horizontal sides with a width sufficient to extend over vertical 4 and horizontal bars 5 of the gate, its frame and beyond these peripheries. A variety of attachment devices including Velcro 6, buttons, zips, clipping mechanisms and a range of fastening solutions can secure mediums (protective assemblies) to parts of the gate, and/or, where required, placement of mediums (protective assemblies), attachment devices as well as the gates own attachment points 7, outside these parameters is incorporated. Nets 8 associated with mediums (protective assemblies), for example, between bar to bar cushioning 9, can act as an intermediate solution to contact through and/or with part/all of the gate's surface. Nets can be removed and/or interchanged, depending on the type and style of medium (protective assembly). Mediums (protective assemblies) can be partly or completely, wipe-able and reversible depending on type and style. The invention further comprises the subject matter of the following statements:

A medium (protective assembly), application, cover, system, barrier, padding, method, device, obstacle, protrusion, attachment, offering intervention, mediation and/or deterring against impact with gates.

A medium (protective assembly) according to the above statement, having panels or a singular panel spaced a distance apart in horizontally and vertically spaced relation, comprising: a width sufficient to partly cover or extend over the whole gate including the gate door and beyond, with or without netting.

A medium (protective assembly) according to the first statement, having at least one end secured to a respective bar of the gate frame and/or at the gate frame and gate door and outside the gate's region where it allows contact against the gate to be mediated.

A medium (protective assembly), according to any of the above statements and/or having at least one end, and/or point for additional pieces to be attached and/or unravelled and/or unwound and/or revealed.

A medium (protective assembly), according to any of the above statements, where components first outer layer is followed by inner layers to form an obstacle with respect to the gate's surface and/or arrangement.

An medium (protective assembly), according to any of the above statements, over, at, around, or in the region of a gate, which provides an intermediate layer to impact on the gate, having an outer layer of a breathable or non-breathable, allergenic or non-allergenic material, with inner layers.

A medium (protective assembly), according to any of the above statements, deterring and/or offering protection at a gate, comprising a piece around at least part of the gate or in its region, so as to prevent or reduce contact with a hard or rigid surface of the gate and its arrangement.

A medium (protective assembly), method, obstacle according to any above statement, which prevents or minimises contact with a gate arrangement or a nursery device acting as a barrier to entry.

A medium (protective assembly), method, obstacle on, over, at, around or in the region of a gate, according to any preceding statement, in which some or all the medium deters from contact with exposed surfaces of the gate.

A medium (protective assembly), method, obstacle to contact with a gate, according to any preceding statement, in which the medium (protective assembly) in operation relates to a gate where the gate is a single gate or two or more gates or gate pieces joined together to form a gated barrier.

A medium (protective assembly), method, obstacle to contact with a gate, according to any preceding statement, in which inner and outer layers or a singular piece comprise natural or synthetic layers of material.

A medium (protective assembly), method, obstacle to contact with a gate, according to any preceding statement, in which the layers are flexible or rigid, made from fabric or fabric-like material including natural or synthetic materials.

A medium (protective assembly), method, obstacle to contact with a gate according to any preceding statement in which the material is a knitted or newly developed material over, on, at around or in the region of gates or gated enclosures.

A medium (protective assembly), method, obstacle to contact with a gate according to any preceding statement in which the layers are a single layer, a double layer, a triple layer, or a multiple layer having a number of layers of material joined together.

A medium (protective assembly), method, obstacle to contact with a gate according to any preceding statement, which has a vacuum.

A medium (protective assembly), method, obstacle to contact with a gate, according to any preceding statement, in which the layers are formed from a single sheet of material or materials by being folded to form two or more layers.

A medium (protective assembly), method, obstacle to contact with a gate according to any preceding statement, in which the layer or layers are made from a multitude of separate sheets or strips joined together or from forming a laminate structure of multiple layers.

A medium (protective assembly), method, obstacle to contact with a gate according to any of the above statements, which includes any inflatable, expandable, contracting features, devices and/or materials, glow in the dark, musical and/or educational features.

A tubular system according to any preceding statement.

A decorative arrangement attached to any of the above statements.

Additional examples of the invention will be described by referring to the accompanying drawings although styles, variations and methods of mediums (protective assemblies) may extend beyond these examples:

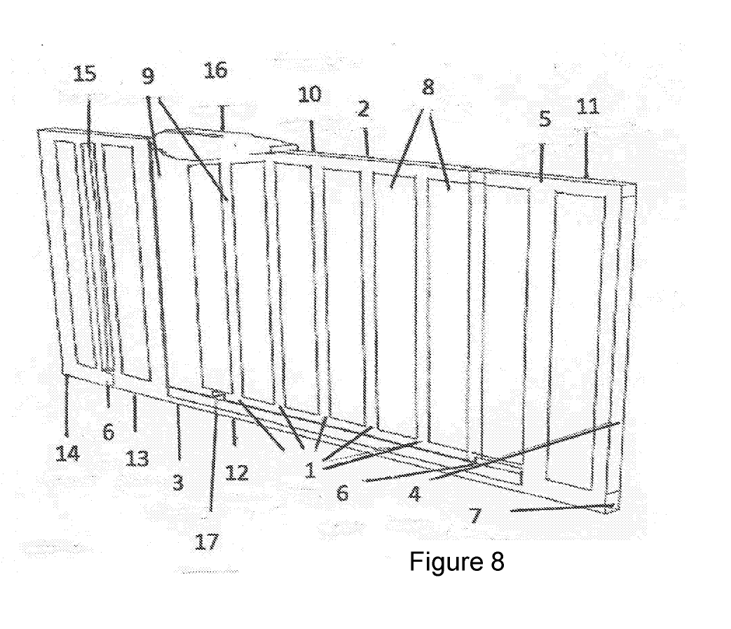

FIG. 8 shows one type of medium (protective assembly) which can be applied to a standard gate. The gate door element to the system is applied to the gate door 10. The system extends back over the part of the gate situated behind the gate door hinge 11. The system travels along the base 12 and over the remainder of the gate 13 and a separate piece attaches to the gate extension 14. The system is secured to the gate with Velcro 6. The extension system secures to the extension 15 and the system with Velcro 6. Nets 8 between bars allow visibility through the gate and prevent infants being caught between bars. A handle piece 16 covers the handle. Spaces in the system allow for wall attachment points 7 and movement of the gate's latch 17.

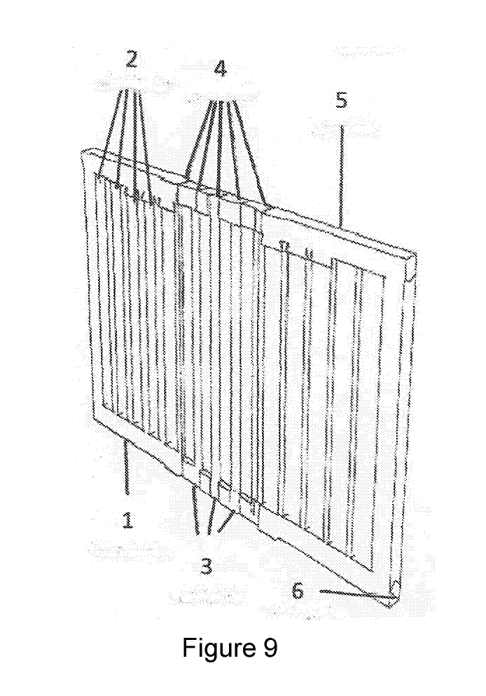

FIG. 9 shows one type of medium (protective assembly) which can be applied to an extendable gate. A side piece 1 is slid onto one side of the gate with incorporated netting 2. Extension pieces 3 cover the central extendable section of the gate. The extension pieces are secured to the side piece 1 and each other using Velcro strips at 4. A second side piece 5 adjoins the extension pieces to complete the solution. Spaces in the medium (protective assembly) for wall attachment allow the gate to be fitted 6.

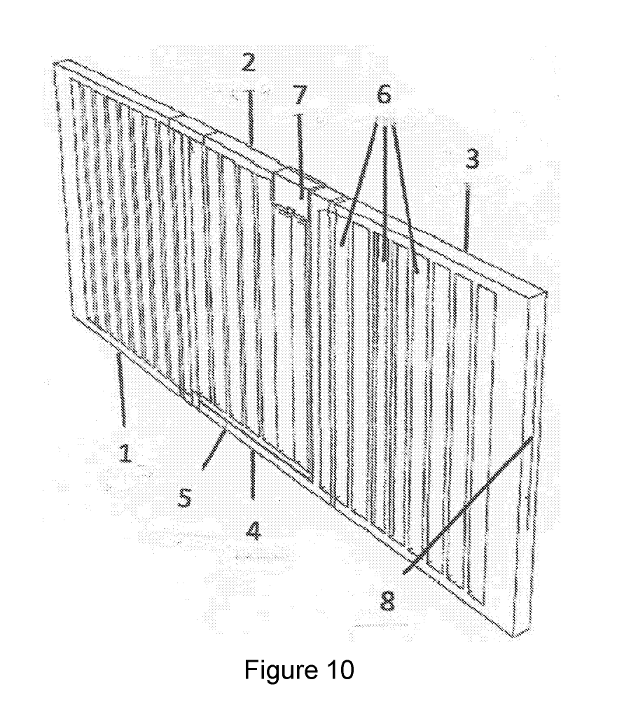

FIG. 10 shows one type of medium (protective assembly) which can be applied to a configure gate arrangement. The first section, 1, of the medium (protective assembly), is slid on to one end of the gate. The second section 2 continues over the gate door. The third section 3 of the medium (protective assembly) is slid onto the opposite end of the gate and the base of the gate slides into the channel of the medium (protective assembly) 4 where the system is secured to the gate with Velcro 5. Nets between bars 6 allow visibility through the gate. A separate handle piece covers the handle 7. Spaces for wall attachment allow the gate to be fitted 8.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A protective assembly for a gate or a barrier structure, the gate or barrier structure being of the type comprising a frame and a plurality of vertical bars, the gate or barrier structure having an inside face and an outside face, wherein the frame is made up of an upper rail and a lower rail, and two end rails, a left end rail running from the left hand end of the upper rail to the left hand end of the lower rail, and a right end rail running from the right hand end of the upper rail to the right hand end of the lower rail, where these end rails are positioned vertically in use, and wherein the vertical bars are located between the two end rails and in use are parallel to these end rails and each other and extend from the upper rail to the lower rail, the protective assembly comprising:
a flexible padding structure comprising a padding material, and
one or more fasteners,
wherein the flexible padding structure is sized and shaped to correspond with a size and a shape of the frame and a size and a shape of the plurality of vertical bars, and
wherein, in use, the flexible padding structure is fitted on the gate or barrier structure and fastened thereto by the one or more fasteners, and extends over an outer surface thereof so as to cover substantially an entire external surface area of the frame and the vertical bar elements of the barrier or gate structure, with there being padding material provided over most or all of the frame, and with there being padding material provided over most or all of the vertical bars, and with there being padding material provided over most or all of the inside face, and with there being padding material provided over most or all of the outside face.

2. The protective assembly according to claim 1, wherein the frame and vertical bar elements which form the barrier or gate structure comprise three or more of the vertical bars, wherein these vertical bars are located between the end rails and in use are parallel to these end rails and each other and extend from the upper rail to the lower rail,
and wherein in use the flexible padding structure is fitted on the gate or barrier structure and fastened thereto by the fasteners, and extends over the outer surface thereof so as to cover substantially the entire external surface area of the frame and the vertical bar elements of the barrier or gate structure, with there being padding material provided over most or all of the frame, and with there being padding material provided over most or all of the vertical bars, and with there being padding material provided over most or all of the inside face, and with there being padding material provided over most or all of the outside face.

3. The protective assembly according to claim 2, wherein the barrier or gate structure comprises four or more vertical bars.

4. The protective assembly according to claim 1, wherein the flexible padding structure is a single piece flexible padding structure that is sized and shaped to correspond with the size and shape of the frame and the size and shape of the plurality of vertical bars, and wherein, in use, the flexible padding structure is fitted as one piece on the gate or barrier structure and is fastened thereto by the fasteners, and extends continuously over the outer surface thereof so as to cover substantially the entire external surface area of the frame and the vertical bar elements of the barrier or gate structure, with there being padding material provided over most or all of the frame, and with there being padding material provided over most or all of the vertical bars, and with there being padding material provided over most or all of the inside face, and with there being padding material provided over most or all of the outside face.

5. The protective assembly according to claim 1, wherein, in use, the flexible padding structure is fitted on the gate or barrier structure and fastened thereto by the fasteners, and extends over the outer surface thereof so as to cover the entire external surface area of the frame and vertical bar elements of the barrier or gate structure, with there being padding material provided over most or all of the frame, and with there being padding material provided over most or all of the vertical bars, and with there being padding material provided over all of the inside face, and with there being padding material provided over all of the outside face.

6. The protective assembly according to claim 1, wherein the flexible padding structure comprises:
one or more internal layer that, in use, is in contact with the barrier or gate, and
one or more outer layer.

7. The protective assembly according to claim 6, wherein padding material is located between the internal layer and the outer layer.

8. The protective assembly according to claim 1, wherein the barrier or gate structure has one or more additional sections, in addition to the frame and the plurality of vertical bars, and wherein, in use, the flexible padding structure further extends over an outer surface of said additional sections, so as to cover substantially an entire external surface area of the additional sections, with there being padding material provided over most or all of the additional sections.

9. The protective assembly according to claim 8, wherein the flexible padding structure is provided as a single piece unit, which is sized and shaped to correspond with the size and shape of the frame and the size and shape of the plurality of vertical bars and a size and shape of the additional sections, and wherein, in use, the flexible padding structure is fitted on the gate or barrier structure and on the additional sections, and fastened thereto by the fasteners, and extends over the outer surface thereof so as to cover substantially the entire external surface area of the frame and the vertical bar elements and the additional sections.

10. The protective assembly according to claim 8, wherein the flexible padding structure comprises a first part which is a single piece unit sized and shaped to correspond with the size and shape of the frame and plurality of vertical bars and wherein, in use, the flexible padding structure is fitted on the gate or barrier structure and fastened thereto by the fasteners, and extends over the outer surface thereof so as to cover substantially the entire external surface area of the frame and the vertical bar elements and wherein the flexible padding structure comprises a second part that comprises one or more separate pieces sized and shaped to correspond with the size and shape of the additional sections and wherein, in use, said separate pieces are fitted on the additional sections and are fastened thereto by fasteners, and these separate pieces extend over the outer surface thereof so as to cover substantially the entire external surface area of the additional sections.

11. The protective assembly according to claim 1, wherein the one or more additional sections are selected from: fixed sections, floor base bars and other support elements, handles, gate extensions, and combinations thereof.

12. The protective assembly according to claim 1, wherein the gate or barrier structure is used to seal off doorways or stairways.

13. The protective assembly according to claim 1, wherein the gate or barrier structure is the barrier of a playpen, crib or room divider.

14. A protected gate or barrier structure, which comprises:
a gate or barrier structure comprising a frame and a plurality of vertical bars, the gate or barrier structure having an inside face and an outside face, wherein the frame is made up of an upper rail and a lower rail, and two end rails, a left end rail running from the left hand end of the upper rail to the left hand end of the lower rail, and a right end rail running from the right hand end of the upper rail to the right hand end of the lower rail, where these end rails are positioned vertically in use, and wherein the vertical bars are located between the two end rails and in use are parallel to these end rails and each other and extend from the upper rail to the lower rail; and
a protective assembly comprising:
a flexible padding structure comprising padding material, and
one or more fastener,
wherein the flexible padding structure is sized and shaped to correspond with the size and shape of the frame and the size and shape of the plurality of vertical bars,
wherein the protective assembly is fitted on the gate or barrier structure by virtue of the flexible padding structure being fitted on the gate or barrier structure and fastened thereto by the fasteners, such that the flexible padding structure extends over the outer surface thereof so as to cover substantially an external surface area of the frame and the vertical bars of the barrier or gate structure, with there being padding material provided over most or all of the frame, and with there being padding material provided over most or all of the vertical bars, and with there being padding material provided over most or all of the inside face, and with there being padding material provided over most or all of the outside face.

15. The protected gate or barrier structure of claim 14, wherein the protective assembly comprises a flexible padding structure which is fitted around most, substantially all, or all of the external surface area of the gate or barrier structure.

16. The protected gate or barrier structure of claim 14, wherein the protective assembly is permanently fastened to the gate or barrier structure.

17. The protected gate or barrier structure of claim 14, wherein 75% or more of the external surface area of the gate or barrier structure is covered by the flexible padding structure.

18. The protected gate or barrier structure of claim 17, wherein 85% or more of the external surface area of the gate or barrier structure is covered by the flexible padding structure.

19. (canceled)

20. A kit comprising a protective assembly in combination with a gate or barrier structure comprising a frame and a plurality of vertical bars, the gate or barrier structure having an inside face and an outside face, wherein the frame is made up of an upper rail and a lower rail, and two end rails, a left end rail running from the left hand end of the upper rail to the left hand end of the lower rail, and a right end rail running from the right hand end of the upper rail to the right hand end of the lower rail, where these end rails are positioned vertically in use, and wherein the vertical bars are located between the two end rails and in use are parallel to these end rails and each other and extend from the upper rail to the lower rail,
wherein the protective assembly comprises:
a flexible padding structure comprising padding material, and
one or more fastener,
wherein the flexible padding structure is sized and shaped to correspond with the size and shape of the frame and the size and shape of the plurality of vertical bars,
wherein, in use, the flexible padding structure is fitted on the gate or barrier structure and fastened thereto by the fasteners, and extends over the outer surface thereof so as to cover substantially the entire external surface area of the frame and the vertical bar elements of the barrier or gate structure, with there being padding material provided over most or all of the frame, and with there being padding material provided over most or all of the vertical bars, and with there being padding material provided over most or all of the inside face, and with there being padding material provided over most or all of the outside face.

21. The protected gate or barrier structure of claim 14, wherein the protective assembly is releasably fastened to the gate or barrier structure.
